(19) United States
(12) Patent Application Publication
(10) Pub. No.: US 2023/0295049 A1
(43) Pub. Date: Sep. 21, 2023

(54) LI-METAL OXIDE/GARNET COMPOSITE THIN MEMBRANE AND METHOD OF MAKING

(71) Applicant: CORNING INCORPORATED, CORNING (US)

(72) Inventors: Michael Edward Badding, Campbell, NY (US); Yinghong Chen, Painted Post, NY (US); Aaron David DeGeorge, Painted Post, NY (US); Zhen Song, Painted Post, NY (US)

(21) Appl. No.: 18/021,497

(22) PCT Filed: Aug. 9, 2021
(86) PCT No.: PCT/US21/45176

§ 371 Date: Feb. 15, 2023

Related U.S. Application Data
(60) Provisional application No. 63/068,506, filed on Aug. 21, 2020.

(51) Int. Cl. C04B 35/488; C04B 35/16; H01M 10/0562; C04B 35/63; C04B 35/626

(52) U.S. Cl. CPC C04B 35/488; C04B 35/16; H01M 10/0562; C04B 35/6316; C04B 35/62685; C04B 2235/764; C04B 2235/3436; C04B 2235/78; H01M 2300/0077; C04B 2235/6025; C04B 2235/6027; C04B 2235/6562; C04B 2235/6565; C04B 2235/6567

(57) ABSTRACT

A sintered composite ceramic, includes: a lithium-garnet major phase; and a lithium dendrite growth inhibitor minor phase, such that the lithium dendrite growth inhibitor minor phase has a Li-metal oxide in a range of >0-10 wt. % based on the total weight of the sintered composite ceramic.

This application claims the benefit of priority under 35 U.S.C. § 119 of U.S. Provisional Application Ser. No. 63/068,506 filed on Aug. 21, 2020, the content of which is relied upon and incorporated herein by reference in its entirety.

### BACKGROUND

### 1. Field

This disclosure relates to lithium-garnet composite ceramic electrolytes with improved critical current density (CCD).

### 2. Technical

Conventional lithium (Li)-ion batteries have been widely studied but still suffer from limited capacity density, energy density, and safety concerns, posing a challenge for large-scale application in electrical equipment. For example, while solid-state lithium batteries based on Li-garnet electrolyte (LLZO) address the safety concerns, insufficient contact between the Li anode and garnet electrolyte due to the rigid ceramic nature and poor lithium wettability of garnet, as well as surface impurities, often lead to large polarization and large interfacial resistances, thereby causing inhomogeneous deposition of lithium and lithium dendrites formation.

Thus, as a result of poor contact between the Li anode and garnet electrolyte, the battery may experience a low critical current density (CCD) and eventual short circuiting.

The present application discloses improved lithium-garnet composite ceramic electrolytes for enhanced grain boundary bonding of Li-garnet electrolytes in solid-state lithium metal battery applications.

### SUMMARY

In some embodiments, a sintered composite ceramic, comprises: a lithium-garnet major phase; and a lithium dendrite growth inhibitor minor phase, wherein the lithium dendrite growth inhibitor minor phase comprises a Li-metal oxide in a range of >0-10 wt. % based on the total weight of the sintered composite ceramic.

In one aspect, which is combinable with any of the other aspects or embodiments, the lithium-garnet major phase comprises at least one of: (i) Li₇₋₃ₐLa₃Zr₂LₐO₁₂, with L=Al, Ga or Fe and 0<a<0.33; (ii) Li₇La_{3-b}Zr₂M_{b}O₁₂, with M=Bi, Ca, or Y and 0<b<1; (iii) Li_{7-c}La₃(Zr_{2-c}, N_{c})O₁₂, with N=In, Si, Ge, Sn, Sb, Sc, Ti, Hf, V, W, Te, Nb, Ta, Al, Ga, Fe, Bi, Y, Mg, Ca, or combinations thereof and 0<c<1, or a combination thereof. In one aspect, which is combinable with any of the other aspects or embodiments, the lithium-garnet major phase comprises: Li_{7-c}La₃(Zr_{2-c}, N_{c})O₁₂, with N=Ta, Ga, W, or combinations thereof, and 0<c<1. In one aspect, which is combinable with any of the other aspects or embodiments, the Li-metal oxide comprises: Li-silicate, Li-gallate, Li-aluminate, Li-tungstate, Li-molinate, Li—Ta oxide, Li—Nb-oxide, Li—Sn-oxide, Li—In-oxide, Li—As-oxide, Li—Sb-oxide, Li-phosphate, or combinations thereof.

In one aspect, which is combinable with any of the other aspects or embodiments, the metal oxide comprises Li-silicate. In one aspect, which is combinable with any of the other aspects or embodiments, the lithium-garnet major phase comprises at least 90 wt. % of a lithium garnet cubic phase. In one aspect, which is combinable with any of the other aspects or embodiments, a maximum grain size measured for a population of grains representing at least 5% of a total grain population does not exceed an average grain size of the total grain population by more than a multiple of 20. In one aspect, which is combinable with any of the other aspects or embodiments, the sintered composite ceramic comprises a membrane having a thickness in a range of 30-150 μm. In one aspect, which is combinable with any of the other aspects or embodiments, the membrane has a Li-ion conductivity of at least 10⁻⁴ S/cm and a relative density of at least 90% of a theoretical maximum density of the membrane.

In some embodiments, a battery comprises: at least one lithium electrode; and an electrolyte in contact with the at least one lithium electrode, wherein the electrolyte is a lithium-garnet composite electrolyte comprising a sintered composite ceramic described herein.

In some embodiments, a sintered composite ceramic, comprises: a lithium-garnet major phase; and a lithium dendrite growth inhibitor minor phase, wherein: the lithium-garnet major phase comprises: Li_{7-c}La₃(Zr_{2-c}, N_{c})O₁₂, with N=Ta, Ga, W, or combinations thereof, and 0<c<1, and the lithium dendrite growth inhibitor minor phase comprises Li-silicate in a range of >0-10 wt. % based on the total weight of the sintered composite ceramic.

In one aspect, which is combinable with any of the other aspects or embodiments, the lithium-garnet major phase comprises at least 90 wt. % of a lithium garnet cubic phase. In one aspect, which is combinable with any of the other aspects or embodiments, a maximum grain size measured for a population of grains representing at least 5% of a total grain population does not exceed an average grain size of the total grain population by more than a multiple of 20. In one aspect, which is combinable with any of the other aspects or embodiments, the sintered composite ceramic comprises a membrane having a thickness in a range of 30-150 μm.

In some embodiments, a sintered composite ceramic, comprises: a lithium-garnet major phase; and a lithium dendrite growth inhibitor minor phase, wherein the sintered composite ceramic comprises at least one of: a Li-ion conductivity of at least 10⁻⁴ S/cm; and a relative density of at least 90% of a theoretical maximum density of the membrane.

In some embodiments, a method comprises: sintering a metal oxide component/garnet green tape at a temperature in a range of 950° C. to 1500° C. to form a composite ceramic, comprising: a lithium-garnet major phase; and a lithium dendrite growth inhibitor minor phase, wherein the lithium dendrite growth inhibitor minor phase comprises a Li-metal oxide in a range of >0-10 wt. % based on the total weight of the sintered composite ceramic.

In one aspect, which is combinable with any of the other aspects or embodiments, the sintering comprises: heating from room temperature to the temperature range; holding at the temperature range for a time in a range of 1-20 min; cooling from the temperature range to room temperature, wherein: a heating ramp rate (HRR) for the heating step is 100° C./min<HRR<1000° C./min, and a cooling rate (CR) for the cooling step is 100° C./min<CR<1000° C./min. In one aspect, which is combinable with any of the other aspects or embodiments, the HRR is 250° C./min<HRR<750° C./min, the CR is 250° C./min<CR<750° C./min, and the temperature range is 1100° C. to 1300° C. In one aspect, which is combinable with any of the other aspects or embodiments, the sintered composite ceramic comprises at least one of: a Li-ion conductivity of at least 10⁻⁴ S/cm; and a relative density of at least 90% of a theoretical maximum density of the membrane.

In one aspect, which is combinable with any of the other aspects or embodiments, the metal oxide component/garnet green tape is formed by: reacting an excess Li source with an additive to form a Li-metal oxide (LMO) precursor; mixing the LMO precursor with a passivated garnet powder to form a garnet suspension; adding dispersant, binder, and plasticizer to the garnet suspension to form a slip composition; and tape casting the slip composition. In one aspect, which is combinable with any of the other aspects or embodiments, the additive comprises at least one of: silicone, tungsten trioxide (WO₃), and gallium oxide (Ga₂O₃). In one aspect, which is combinable with any of the other aspects or embodiments, the metal oxide component/garnet green tape is formed by: mixing an excess Li source, a Li-metal oxide (LMO) precursor, and a passivated garnet powder to form a garnet suspension; adding dispersant, binder, and plasticizer to the garnet suspension to form a slip composition; and tape casting the slip composition.

### BRIEF DESCRIPTION OF THE DRAWINGS

The disclosure will become more fully understood from the following detailed description, taken in conjunction with the accompanying figures, in which:

FIG. 1 illustrates a process flow chart for making a Li-metal-oxide/LLZO composite thin membrane, according to some embodiments.

FIG. 2 illustrates an x-ray diffraction (XRD) pattern of an as jet milled Ta-LLZO garnet powder, according to some embodiments.

FIGS. 3A-3D illustrate cross-section scanning electron microscopy (SEM) images of garnet tapes comprising: 0 wt. % silicone (FIG. 3A), 2 wt. % silicone (FIG. 3B), 5 wt. % silicone (FIG. 3C), and 10 wt. % silicone (FIG. 3D), all sintered at 1050° C./3 min, according to some embodiments. The green tape contains 70% excess lithium (Li).

FIG. 4 illustrates Li₂O wt. % versus silica content inside sintered Ga—W-LLZO tapes after sintering at 1050° C./3 min, according to some embodiments.

FIG. 5 illustrates Li-ion conductivity of Ga—W-LLZO tapes sintered at various temperatures for 3 min and comprising different amounts of silicone in their respective green tapes, according to some embodiments.

FIGS. 6A-6D illustrate cross-section SEM images of garnet tapes comprising different amount of excess Li and silicone additives, sintered at 1200° C./5 min, according to some embodiments.

FIGS. 7A-7D illustrate cross-section SEM images of garnet tapes comprising different amount of excess Li and silicone additives, sintered at 1200° C./10 min, according to some embodiments.

FIGS. 8A and 8B illustrate cross-section SEM images of garnet tapes comprising different amount of excess Li and silicone additives, sintered at 1200° C./3 min, according to some embodiments.

FIGS. 9A and 9B illustrate cross-section SEM images of garnet tapes comprising different amount of excess Li and silicone additives, sintered at 1200° C./15 min, according to some embodiments.

FIG. 10 illustrates electrochemical impedance spectroscopy (EIS) curves from garnet membranes with and without silicone additives in green tapes, according to some embodiments.

### DETAILED DESCRIPTION

Reference will now be made in detail to exemplary embodiments which are illustrated in the accompanying drawings. Whenever possible, the same reference numerals will be used throughout the drawings to refer to the same or like parts. The components in the drawings are not necessarily to scale, emphasis instead being placed upon illustrating the principles of the exemplary embodiments. It should be understood that the present application is not limited to the details or methodology set forth in the description or illustrated in the figures. It should also be understood that the terminology is for the purpose of description only and should not be regarded as limiting.

Additionally, any examples set forth in this specification are illustrative, but not limiting, and merely set forth some of the many possible embodiments of the claimed invention. Other suitable modifications and adaptations of the variety of conditions and parameters normally encountered in the field, and which would be apparent to those skilled in the art, are within the spirit and scope of the disclosure.

### Definitions

“Major phase,” “first phase,” or like terms or phrases refer to a physical presence of a lithium garnet in greater than 50 wt. %. Phase components and their concentrations may be measured by XRD (wt. %). In some examples, major phase may also be represented by a physical presence of a lithium garnet in greater than 50 vol. % or greater than 50 mol. %, or like in the composition.

“Minor phase,” “second phase,” or like terms or phrases refer to a physical presence of a lithium dendrite growth inhibitor (i.e., grain boundary bonding enhancer) in less than 50% by weight, by volume, by mols, or like measures in the composition. In some examples, minor phases not detectable by XRD, may be measured by SEM to confirm existence of the minor phase(s).

“SA,” “second additive,” “second phase additive,” “second phase additive oxide,” “phase additive oxide,” “additive oxide,” “additive,” or like terms refer to an additive oxide that produces a minor phase or second minor phase within the major phase when included in the disclosed compositions.

“LLZO,” “garnet,” or like terms refer to compounds comprising lithium (Li), lanthanum (La), zirconium (Zr), and oxygen (O) elements. Optionally, dopant elements may substitute at least one of Li, La, or Zr.

For example, lithium-garnet electrolyte comprises at least one of: (i) Li₇₋₃ₐLa₃Zr₂LₐO₁₂, with L=Al, Ga or Fe and 0<a<0.33; (ii) Li₇La_{3-b}Zr₂M_{b}O₁₂, with M=Bi, Ca, or Y and 0<b<1; (iii) Li_{7-c}La₃(Zr_{2-c},N_{c})O₁₂, with N=In, Si, Ge, Sn, V, W, Te, Nb, or Ta and 0<c<1; (iv) Li₇₋ₓLa₃(Zr₂₋ₓ, Mₓ)O₁₂, with M=In, Si, Ge, Sn, Sb, Sc, Ti, Hf, V, W, Te, Nb, Ta, Al, Ga, Fe, Bi, Y, Mg, Ca, or combinations thereof and 0<x<1, or a combination thereof.

“Include,” “includes,” or like terms means encompassing but not limited to, that is, inclusive and not exclusive.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

For example, in modifying the quantity of an ingredient in a composition, concentrations, volumes, process temperature, process time, yields, flow rates, pressures, viscosities, and like values, and ranges thereof, or a dimension of a component, and like values, and ranges thereof, employed in describing the embodiments of the disclosure, “about” or similar terms refer to variations in the numerical quantity that can occur, for example: through typical measuring and handling procedures used for preparing materials, compositions, composites, concentrates, component parts, articles of manufacture, or use formulations; through inadvertent error in these procedures; through differences in the manufacture, source, or purity of starting materials or ingredients used to carry out the methods; and like considerations. The term “about” (or similar terms) also encompasses amounts that differ due to aging of a composition or formulation with a particular initial concentration or mixture and amounts that differ due to mixing or processing a composition or formulation with a particular initial concentration or mixture.

As utilized herein, “optional,” “optionally,” or the like are intended to mean that the subsequently described event or circumstance can or cannot occur, and that the description includes instances where the event or circumstance occurs and instances where it does not occur. The indefinite article “a” or “an” and its corresponding definite article “the” as used herein means at least one, or one or more, unless specified otherwise.

As used herein, “room temperature” or “RT” is intended to mean a temperature in a range of about 18° C. to 25° C.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

Abbreviations, which are well known to one of ordinary skill in the art, may be used (e.g., “h” or “hrs” for hour or hours, “g” or “gm” for gram(s), “mL” for milliliters, and “RT” for room temperature, “nm” for nanometers, and like abbreviations).

Specific and preferred values disclosed for components, ingredients, additives, dimensions, conditions, times, and like aspects, and ranges thereof, are for illustration only; they do not exclude other defined values or other values within defined ranges. The compositions, articles, and methods of the disclosure can include any value or any combination of the values, specific values, more specific values, and preferred values described herein, including explicit or implicit intermediate values and ranges.

With respect to the use of substantially any plural and/or singular terms herein, those having skill in the art can translate from the plural to the singular and/or from the singular to the plural as is appropriate to the context and/or application. The various singular/plural permutations may be expressly set forth herein for the sake of clarity.

As explained above, solid-state lithium batteries based on Li-garnet electrolyte (LLZO) often suffer from insufficient contact between the Li anode and garnet electrolyte, which often leads to the battery experiencing a low critical current density (CCD) and eventual short circuiting. Conventional approaches to address these issues have included: (A) H₃PO₄ acid treatments for removing impurities while forming a protective interlayer of Li₃PO₄ and (B) modifying the electrolyte-anode interface with SnO₂ and MoS₂ to form Sn, Mo, and related alloy interlayers. However, it was found that for these proposals, as the battery circulates, the interlayers gradually become exhausted and result in eventual battery failure. Moreover, these interlayers do not increase the resistance of the electrolyte itself against lithium dendrite growth.

Composite ceramic electrolytes are effective in improving bonding at the major phase grain boundary, thereby improving CCD by minimizing lithium dendrite growth. Critical current density (CCD) refers to the maximum current density that LLZO electrolyte can tolerate before lithium dendrite penetration occurs in the electrolyte, which affects the dendrite suppression capability of the electrolyte. By adding additives during the LLZO sintering process, the additive or its decomposition product aggregates at the grain boundary to enhance grain boundary bonding and block lithium dendrite growth. Current efforts at studying additives have included (i) LiOH·H₂O in LLZO to form a minor phase of Li₂CO₃ and LiOH or (ii) adding Li₃PO₄ to LLZO precursor and allowing Li₃PO₄ to remain as the minor phase at the grain boundaries by controlling sintering conditions or (iii) adding LiAlO₂-coated LLZO particles to obtain a Li-garnet composite ceramic electrolyte. However, none of (i) to (iii), can achieve a desired CCD to meet the requirements of practical applications.

Garnet is a promising solid electrolyte material for Li-metal battery technology. Li metal anodes allow a much higher energy density than the carbon anodes currently used in conventional Li-ion batteries. Challenges exist in methods of making thin garnet materials. For example, one challenge is Li-dendrite formation, as explained above. A second challenge is the strength requirement for thin membranes, which is determined by battery assembly handling. A fine grain microstructure is desired for high strength.

Disclosed herein is a Li-garnet composite ceramic thin membrane for electrolyte applications prepared by adding a metal oxide into LLZO with optional elemental doping (e.g., at least one of In, Si, Ge, Sn, Sb, Sc, Ti, Hf, V, W, Te, Nb, Ta, Al, Ga, Fe, Bi, Y, Ca, etc., or combinations thereof). Elemental dopants may be used to stabilize LLZO into a cubic phase.

Li-metal-oxides may be used as the grain boundary materials for grain boundary modification such that non- or low-Li-ion conductive material may be used to fill garnet grain boundaries so that Li-ions preferably penetrate through the garnet grains, thereby inhibiting Li-dendrite growth through the grain boundary and inhibiting solid electrolyte critical current densities (CCDs). Low melting temperature of the second phase material may also help to decrease garnet sintering temperature and increase grain bonding strength.

In some examples, the Li-garnet composite ceramic may comprise: a lithium garnet major phase (e.g., LLZO, as defined above) and a lithium dendrite growth inhibitor minor phase (e.g., SA, as defined above). In some examples, the major phase may be doped with at least one of In, Si, Ge, Sn, Sb, Sc, Ti, Hf, V, W, Te, Nb, Ta, Al, Ga, Fe, Bi, Y, Mg, Ca, or combinations thereof and the minor phase comprises a second additive oxide selected from the group Li-silicate, Li-gallate, Li-aluminate, Li-tungstate, Li-molinate, Li—Ta oxide, Li—Nb-oxide, Li—Sn-oxide, Li—In-oxide, Li—As-oxide, Li—Sb-oxide, Li-phosphate, or combinations thereof, present in from >0-10 wt. % based on the total amount of the ceramic. The additive may improve uniformity of the ceramic microstructure and enhance mechanical properties of the ceramic. As used herein “uniformity of the ceramic microstructure” refers to the distribution of grain sizes. The occurrence of abnormally large grains, which can have a detrimental effect on mechanical properties, may be minimized or eliminated and a fine grain microstructure may be achieved. For example, the maximum grain size measured for a population of grains representing at least 5% of the total grains should not exceed the average grain size by more than a multiple of 20.

As disclosed herein, a process of making a dense, fine-grain metal oxide/garnet composite thin membrane structure is described with an identified composite composition that results in a test cell having improved CCD, as compared with cells not comprising the metal oxide/garnet composite thin membrane.

The following Examples demonstrate making, use, and analysis of the disclosed ceramics.

### EXAMPLES

FIG. 1 illustrates a process flow chart for making a metal oxide/LLZO composite thin membranes, according to some embodiments.

### Example 1A—Preparation of Li-Garnet Composite Ceramic Powder (Garnet Powder Making)

### Step 1: First Mixing Step

In the first mixing step, a stoichiometric amount of inorganic materials is mixed together, in the formula of garnet oxides and, for example, milled into fine powder. The inorganic materials can be a carbonate, a sulfonate, a nitrate, an oxalate, a hydroxide, an oxide, or mixtures thereof with the other elements in the chemical formula. For example, the inorganic materials can be, for example, a lithium compound and at least one transition metal compound (e.g., La-based, Zr-based, etc.). In some embodiments, the inorganic materials compounds may also comprise at least one of In, Si, Ge, Sn, Sb, Sc, Ti, Hf, V, W, Te, Nb, Ta, Al, Ga, Fe, Bi, Y, Mg, Ca, or combinations thereof in the chemical formula.

In some embodiments, it may be desirable to include an excess of a lithium source material in the starting inorganic batch materials to compensate for the loss of lithium during the high temperature of from 1000° C. to 1300° C. (e.g., 1100° C. to 1200° C.) sintering/second calcining step. The first mixing step can be a dry mixing process (e.g., tubular mixing followed by dry ball milling, or vice versa), dry milling process, or a wet milling process with an appropriate liquid that does not dissolve the inorganic materials. The mixing time, such as from several minutes to several hours, can be adjusted, for example, according to the scale or extent of the observed mixing performance (e.g., 1 min to 48 hrs, or 30 mins to 36 hrs, or 1 hr to 24 hrs (e.g., 12 hrs), or any value or range disclosed therein). The milling can be achieved by, for example, a planetary mill, an attritor, ball mixing, tubular mixing, or like mixing or milling apparatus.

### Step 2: First Calcining Step

In the first calcining step, the mixture of inorganic material, after the first mixing step, is calcined at a predetermined temperature, for example, at from 800° C. to 1200° C. (e.g., 950° C.), including intermediate values and ranges, to react and form the target Li-garnet. The predetermined temperature depends on the type of the Li-garnet. The calcination time, for example, varies from 1 hr to 48 hrs (e.g., 2 hrs to 36 hrs, or 3 hrs to 24 hrs, or 4 hrs to 12 hrs (e.g., 5 hrs), or any value or range disclosed therein), and also may depend upon on the relative reaction rates of the selected inorganic starting or source batch materials. In some examples, the predetermined temperature is selected independently from the calcination time, for example, 950° C. for 5 hrs or 1200° C. for 5 hrs. In some embodiments, a pre-mix of inorganic batch materials can be milled and then calcinated or calcined, as needed, in a first step.

### Step 3: Second Calcining Step

After the first calcining step, the calcined mixture of inorganic material may be calcined at a higher predetermined temperature for example, at from 1000° C. to 1300° C. (e.g., 1200° C.), including intermediate values and ranges, with a temperature ramping rate (pre-sintering) and cooling rate (post-sintering) ranging from 0.5° C./min to 10° C./min (e.g., 5° C./min). The predetermined temperature for the second calcining depends on the type of the Li-garnet. The calcination time, for example, varies from 1 hr to 48 hrs (e.g., 2 hrs to 36 hrs, or 3 hrs to 24 hrs, or 4 hrs to 12 hrs (e.g., 5 hrs), or any value or range disclosed therein).

In some examples, Steps 2 and 3 may be combined into a single calcining step with two holding phases (the first holding phase represented by Step 2 and the second holding phase represented by Step 3).

### Step 4: Milling Step

After the second calcining step, the powder may be milled by ball milling and/or jet milling with 90 wt. % of the above lithium garnet cubic phase. When ball milling is conducted, the ball milled powder is coarser, having a D50 particle size ranging between 1-5 μm. When jet milling is conducted, the jet milled powder is finer, having a D50 particle size ranging between 0.01-1 μm. Both the coarse and fine powders have approximately a bi-modal particle size distribution. For tape casting, a finer powder having a mono-modal distribution is preferred.

### Step 5: Sieving Step

The milled powder of Step 4 is then filtered by passing through a 100-grit sieve to obtain a final Li-garnet composite ceramic powder having a D50 particle size ranging between 0.01-1 μm (e.g., 0.6 μm). Where the powder is formed as an arbitrary shape, the powder may have at least one dimension ranging from 0.01-1 μm.

### Example 1B

In Example 1B, 0.5Ta-LLZO and Li_{4.9}La₃Zr_{1.7}W_{0.3}Ga_{0.5}O₁₂ composition garnets, respectively, are used in making the composites.

Garnet powder is prepared by a solid-state reaction method, using Li₂CO₃, La₂O₃, ZrO₂ and the corresponding dopant oxides (e.g., Ta-based (e.g., Ta₂O₅), W-based (e.g., WO₃), or Ga-based (e.g., Ga₂O₃)) as the precursors. Because the powders absorb different amounts of adsorbates, the powders (except Li₂CO₃) are measured using TGA (RT-1000C) before batching, and then batched in the amount of powder considering the adsorbates amount. A stoichiometric batch is thoroughly mixed by tubular mixing, followed by ball mixing, and then heated in a single calcining step with a first holding phase conducted at 950° C. for 5 hrs and a second holding phase conducted at 1200° C. for 5 hrs in a Pt crucible with a Pt cover sheet. After calcination, the chunk product is jet milled and then sieved with a 100-grit sieve to obtain a final garnet powder with a D50 of about 0.6 μm.

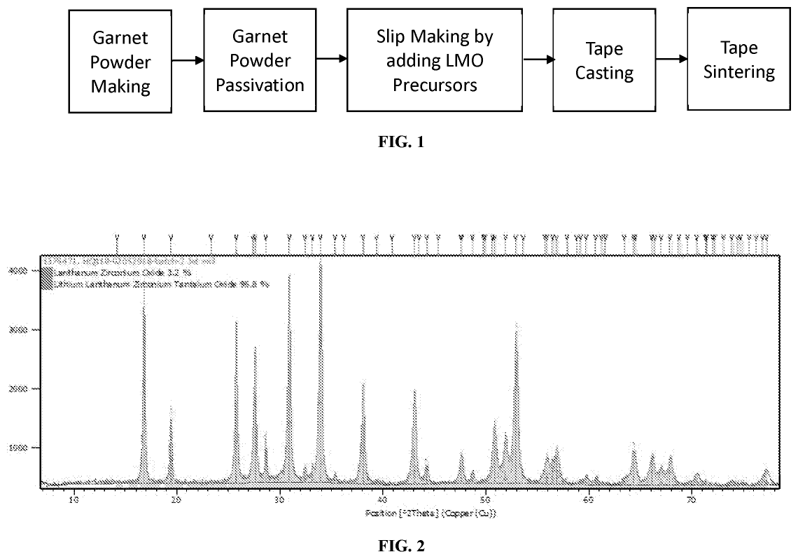

FIG. 2 illustrates an x-ray diffraction (XRD) pattern of an as jet milled Ta-LLZO garnet powder to confirm the composition.

### Example 2—Garnet Powder Passivation

In some embodiments, prior to slip preparation (explained in greater detail below), the garnet powder prepared in Examples 1A or 1B (e.g., Ta-doped LLZO, or analogously, Ga- and/or W-doped LLZO) may be air carbonated or acid treated to passivate its high reactivity with other tape casting slip components. This allows the garnet to be stable when tape casting the slip and as a result, the final green tape may be stable for extended periods of time.

### Garnet Powder Passivation by Air Carbonation

As-made garnet powder (of Examples 1A or 1B) is exposed to air at 50° C. for 1 month. The powder reacts with H₂O and CO₂ in air to form H-LLZO (inner core; H-doped LLZO), with an overlaying Li₂CO₃ outer shell on the garnet powder particles. As stated above, this passivates garnet to prevent garnet reaction with organic components in the slip composition and when tape casting the slips.

### Garnet Powder Passivation by Acid Treatment

In an alternate passivation technique, acid (e.g., HCl, HF, HNO₃, H₃PO₄, H₂SO₄, acetic acid, boric acid, carbonic acid, citric acid, oxalic acid, etc.) is added to a slurry of the as-made garnet powder (of Examples 1A or 1B). Initially, pH of the slurry exceeds 7, but this value gradually decreases by addition of the acid until settling to a desired pH of around 6. Centrifuging the slurry separates the final powder. The obtained testing powder is H-LLZO (protonated garnet) (i.e., no outer Li₂CO₃ shell formation—one composition of protonated garnet) that is stable with the tape casting slip.

### Example 3—Slip Making by Addition of Li-Metal Oxide (LMO) Precursors

In embodiments, the tape casting process begins by making a garnet slip composition. The slip contains at least one solvent, organic binder, plasticizer, lithium garnet powder, an excess lithium source, second additive, and dispersant. A typical slip composition formulation is listed in Table 1, though the lithium garnet powder, an excess lithium source, second additive, and binder content may be varied for achieving a variety of high-quality green tapes.

TABLE 1

| | | Vol. % in | Solvent Vol. % |
|---|---|---|---|
| Component | Name | tape | in slip |
| Garnet | Li-garnet powder | 52.28 | |
| | (from Example 2) | | |
| Excess Li source | Li₂CO₃ | | |
| Second additive | M97E silicone | n % of garnet | |
| | | (variable) | |
| Dispersant | Disperbyk ® 118 | 6.99 | |
| Solvent | n-Butyl propionate | | 65.55% |
| (1:1 wt. %) | n-Propyl propionate | | |
| Binder | Elvacite 2046 | 27.93 | |
| Plasticizer | Dibutyl Phthalate | 12.80 | |

In some examples, the dispersant of the slip composition formulation may be selected from the group comprising: Disperbyk® 118, Disperbyk® 142, Disperbyk® 182, Disperbyk® 2022, Disperbyk® 2155, Solsperse™ 41090, Anti-Terra® 250, Fish oil, or combinations thereof In some examples, the excess Li of the slip composition formulation may be selected from the group comprising: Li₂CO₃, LiCl, LiNO₃, Li-citrate, Li-acetate, Li-oleate, LiF, Li₂SO₄, or combinations thereof.

Slip making includes steps of dispersing the lithium garnet powder, an excess lithium source, and second additive in the solvents to form a garnet suspension. For reference, Li₂CO₃ is added as an excess lithium source (Li precursor). In the initial slip making steps, M97E silicone (Si precursor), which contains 50 wt. % SiO₂, functions as a pseudo-binder/plasticizer (in addition to the added binder and plasticizer in green tape formation). During sintering, M97E silicone may decompose and react with Li₂CO₃ to form Li-silicate. Similarly, for slip composition formulations comprising a second additive of a tungsten-based compound (e.g., WO₃) and/or a gallium-based compound (e.g., Ga₂O₃), a Li-tungstate and a Li-gallate, respectively, may be formed via each's reaction with Li₂CO₃. In some examples, metal oxides or other form precursors (e.g., WO₃, Ga₂O₃, etc.) may be added into the slip as a second additive, and tape cast to a green tape. During the step of sintering, these metal oxides or precursors react with Li₂CO₃ to form Li-tungstate, Li-gallate, etc., respectively, in situ. Thereafter, each of the Li-silicate, Li-tungstate, and/or Li-gallate is mixed with the lithium garnet powder in the solvents to form the garnet suspension. Finally, the dispersant, binder, and plasticizer are added to the garnet suspension, milled (e.g., attrition milling at 2000 rpm for 1-5 hrs (e.g., 2 hrs)) and de-aired under vacuum for 5 to 10 min. The milling and mixing may be conducted under vacuum and chilling to prevent inadvertent reaction between the garnet and other slip components.

### Example 4—Tape Casting

The tape casting process includes, for example, slip making (described above), tape casting, and drying (sintering, described below). Tape casting may be conducted using a 6 mil to 18 mil blade, for example. Table 1 is an example of a slip composition that may be used for tape casting a Li-silicate/garnet composite green tape.

### Green Tape With and Without Silicone

Table 2 shows a comparison of experimental tape casting conditions used for characterization. The slip compositions of Conditions 1-3 from Table 2 are tape cast by first heating at 950° C. for 2 hrs in an inert environment (N₂). After the powder has cooled, it is tape cast immediately. Stability of the resultant green tape is qualitatively described in Table 2. When a tape becomes fragile (i.e., brittle, cracking), this indicates that organic materials (binder, plasticizer) contained therein are decaying, which may be a result of reaction with active garnet. Thus, in Table 2, “flexible” may be categorized as when a green tape is bent at 90° and still does not crack.

TABLE 2

| | Slip | Garnet Powder | Green Tape |
|---|---|---|---|
| Condition No. | composition | Passivated? | Stability |
| 1 | Table 1, | No | Fragile in < 1 |
| | minus silicone | | week |
| 2 | Table 1 | No | Flexible retained |
| | | | for months |
| 3 | Table 1 | Example 2, passivation | Flexible retained |
| | | by air carbonation | for months |

### Example 5—Tape Sintering

Garnet tapes were sintered in both air and argon (Ar) atmosphere. During sintering, green tapes were carried on a setter (e.g., alumina, MgO, ZrO₂, grafoil) or suspended in air. When a setter is used, the green garnet tapes may be sandwiched in between setter sheets to retain lithium. No mother powder is needed. Two types of sintering methods may be used: conventional sintering and fast sintering. In conventional sintering, the temperature ramping rate is in a range of 100° C./hr to 600° C./hr. In fast sintering, the temperature ramping rate is in a range of 100° C./min to 1000° C./min. Li-loss in fast sintering is significantly reduced and as a result, green tapes may be sintered in ambient air without any covering. To prevent thermal shock, the setters are preferred in thin film form (ceramic thin sheet or ceramic ribbon). For conventional sintering, an Ar or nitrogen (N₂) atmosphere is preferred.

### Silicone/Ga- and W-doped LLZO Tapes

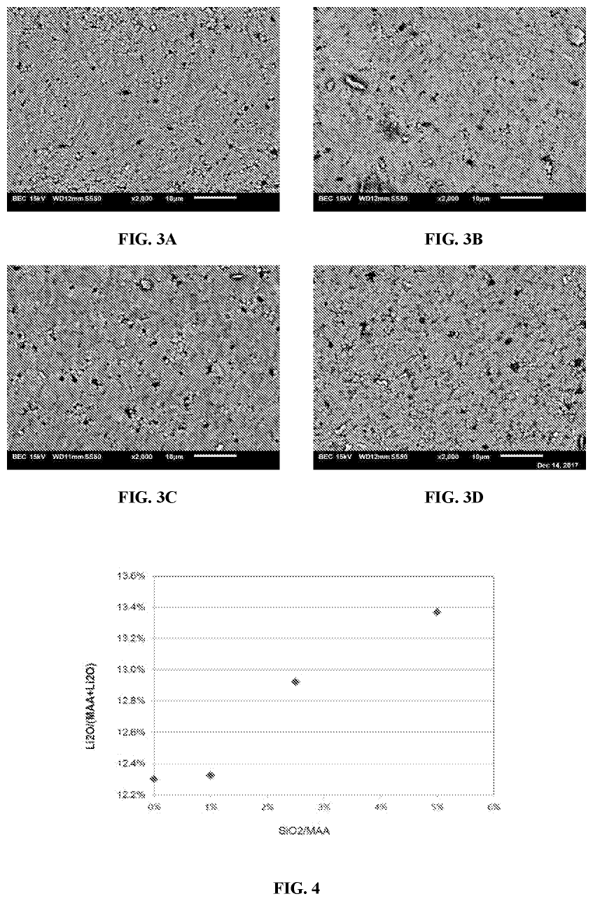

In one example, slip compositions were prepared with 0.5Ga-0.3W-LLZO garnet, varying amounts of silicone (in a range of 0 wt. % to 10 wt. %), and 70% excess Li (as Li₂CO₃, with respect to the Li amount in garnet) and tape cast. The tape cast green tape were sintered in air with a temperature ramping speed of 450° C./min to temperatures in a range of 1000° C. to 1200° C. for 3 min. FIGS. 3A-3D illustrate cross-section scanning electron microscopy (SEM) images of the garnet tapes (˜70 μm) comprising: 0 wt. % silicone (i.e., no Li-silicate) (FIG. 3A), 2 wt. % silicone (FIG. 3B), 5 wt. % silicone (FIG. 3C), and 10 wt. % silicone (FIG. 3D), all sintered at 1050° C./3min The green tape contains 70% excess lithium (Li). The 10 wt. % silicone sample shows a slightly looser grain structure.

FIG. 4 illustrates Li₂O wt. % versus silica content inside the sintered Ga—W-LLZO tapes after sintering at 1050° C./3min, as measured by inductively coupled plasma (ICP). As silicone content increases, for example, from 0 wt. % to 2 wt. % to 5 wt. % to 10 wt. %, so does the Li₂O wt. % inside the sintered Ga—W-LLZO tapes. As explained above, during sintering, silicone decomposes and reacts with Li₂CO₃ to form Li-silicate. Thus, Li loss is mitigated by the Li being preserved as Li-silicate in the sintered garnet tape such that at least some silicone content is advantageous over tapes with 0 wt. % silicone.

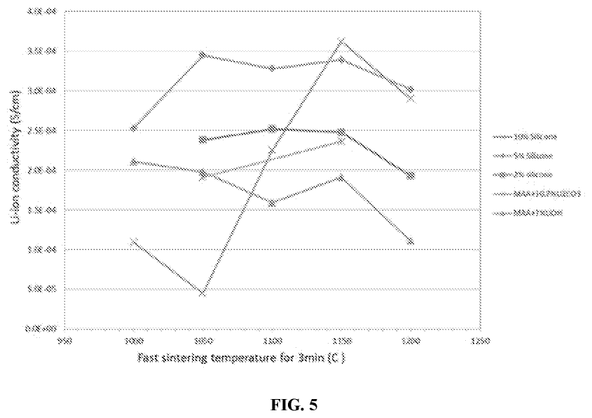

Investigating electrical properties, FIG. 5 illustrates Li-ion conductivity of Ga—W-LLZO tapes sintered at various temperatures for 3 min and comprising different amounts of silicone in their respective green tapes, as measured by electrochemical impedance spectroscopy (EIS) using gold (Au) electrodes. When a second phase is added at the grain boundary, it is expected Li-ion conductivity would severely decrease. However, unexpectedly, for tapes comprising a silicone content in a range of 0 wt. % to 5 wt. %, Li-ion conductivity increases as the amount of silicone in the tape increases, varying 1×10⁻⁴ to 3.5×10⁻⁴ S/cm. This increase in Li-ion conductivity may be an indication that more Li is retained in the samples, confirming that silicone or Li-silicate helps to reduce Li-loss. Without being bound by theory, for higher levels of silicone (e.g., 10 wt. %), lower conductivities at lower sintering temperatures may be due to the tapes not sufficiently densifying during the sintering process. This indicates that too high of silica content (from the silicone) increases sintering temperature of the garnet. Thus, at silicone contents greater than 10 wt. %, sintering temperatures may become undesirably high.

In some examples, the silicone content may be present in a range of >0 wt. % to 10 wt. %, or >0 wt. % to 8 wt. %, or >0 wt. % to 5 wt. %, or 5 wt. % to 10 wt. %, or 2 wt. % to 10 wt. %, or any value or sub-range disclosed therein.

Table 3 describes XRD-measured phase compositions of the thin garnet sintered membranes having varying amounts of silicone and sintered at varying conditions (if not labelled, tape is fast sintered).

TABLE 3

| Ga-W-LLZO + | | |
|---|---|---|
| silicone content | | |
| (wt. %) | Sintering Condition | Phase Quantification |
| 0 | 1000° C./20 min + | 94 wt. % cubic garnet |
| | 95° C./6 hrs | 4 wt. % LiGaO₂ |
| | (Conventional Sintering) | 2 wt. % LaGaO₃ |
| 0 | 1050° C./3 min | 95 wt. % cubic garnet |
| | | 3 wt. % LiGaO₂ |
| | | 2 wt. % ZrO₂ |
| 5 | 1000° C./20 min + | 94 wt. % cubic garnet |
| | 95° C./6 hrs | 5 wt. % LiGaO₂ |
| | (Conventional Sintering) | 1 wt. % Li₄WO₅ |
| 5 | 1050° C./3 min | 96 wt. % cubic garnet |
| | | 3 wt. % LiGaO₂ |
| | | 1 wt. % Li₄WO₅ |
| 5 | 1100° C./5 min | 95 wt. % cubic garnet |
| | | 4 wt. % LiGaO₂ |
| | | 1 wt. % Li₂WO₄ |
| 5 | 1200° C./3 min | 91 wt. % cubic garnet |
| | | 6 wt. % LiGaO₂ |
| | | 2 wt. % ZrO₂ |
| | | Possible 1 wt. % Li₂WO₄ |
| 10 | 1000° C./3 min | 93 wt. % cubic garnet |
| | | 5 wt. % LiGaO₂ |
| | | 3 wt. % ZrO₂ |
| 10 | 1200° C./3 min | 91 wt. % cubic garnet |
| | | 3 wt. % LiGaO₂ |
| | | 4 wt. % La₂Zr₂O₇ |
| | | 2 wt. % ZrO₂ |

All samples have high concentrations of cubic garnet phase (e.g., >90 wt. %). High cubic phase ensures a high ionic conductivity. The presence of LiGaO₂, LaGaO₃, La₂Zr₂O₇, Li₄WO₅, Li₂WO₄, ZrO₂, etc. are auxiliary products of ion-exchange between Li—Ga, Si—W, Si—Zr, etc. The auxiliary products as well as the Li-silicate second phase stay at the grain boundary or the tri-boundary points. Because the Ga—W-LLZO composition is a low-Li composition and because the system contains high excess Li, garnet does not decompose at the tested firing conditions.

### Silicone/Ta-doped LLZO Tapes

In one example, slip compositions were prepared with 0.5Ta-LLZO garnet, varying amounts of silicone (in a range of 0 wt. % to 10 wt. %), and either 15% or 50% excess Li (as Li₂CO₃, with respect to the Li amount in garnet) and tape cast. The tape cast green tape were sintered in air with a temperature ramping speed of 450° C./min to temperatures in a range of 1000° C. to 1200° C. for 3 min. Table 4 summarizes sintering conditions for the various green tape compositions.

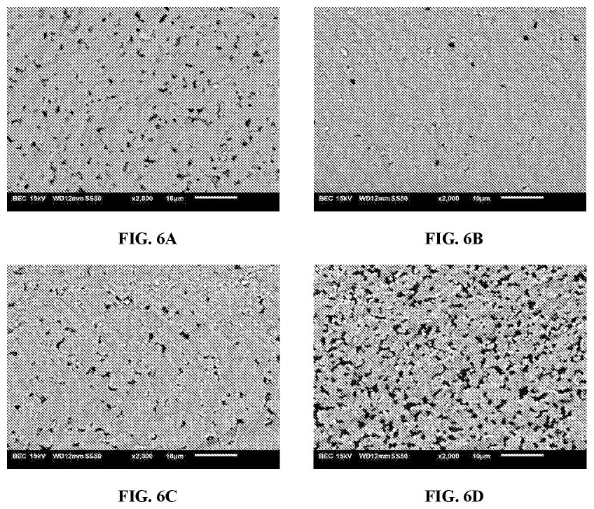

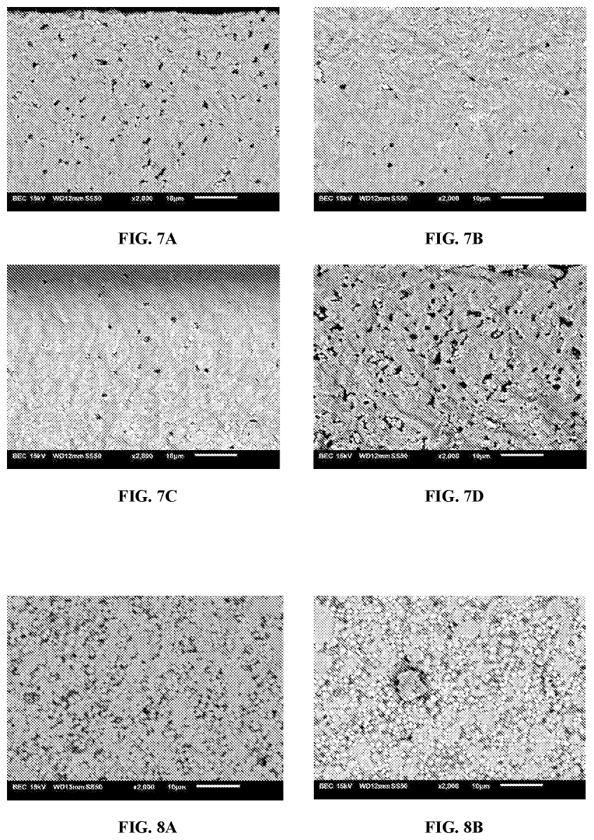

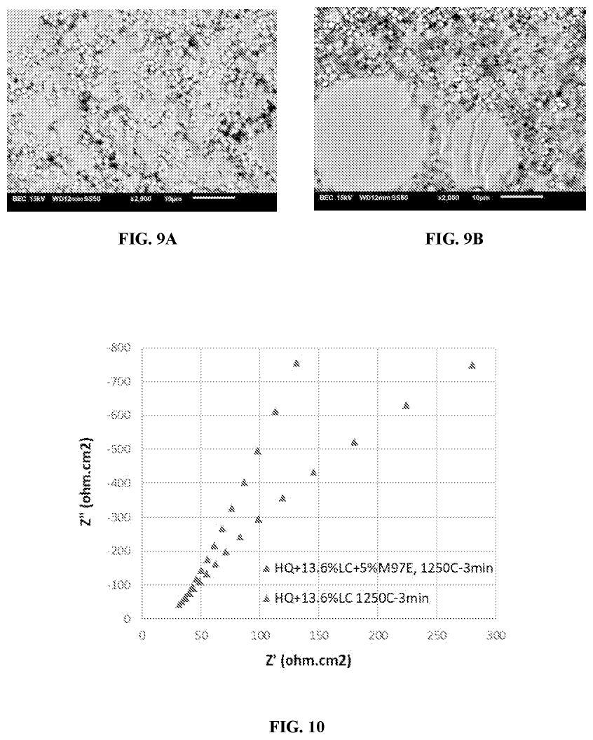

TABLE 4

| Ta-LLZO + silicone | Excess Li | Sintering | Microstructure |
|---|---|---|---|
| content (wt. %) | Content (%) | Condition | Cross-Section |
| 0 | 15 | 1200° C./5 min | FIG. 6A |
| 2 | | | FIG. 6B |
| 5 | | | FIG. 6C |
| 8 | | | FIG. 6D |
| 0 | | 1200° C./10 min | FIG. 7A |
| 2 | | | FIG. 7B |
| 5 | | | FIG. 7C |
| 8 | | | FIG. 7D |
| 0 | 50 | 1200° C./3 min | FIG. 8A |
| 5 | | | FIG. 8B |
| 0 | | 1200° C./15 min | FIG. 9A |
| 5 | | | FIG. 9B |

FIGS. 6A-9B illustrate cross-section SEM images of garnet tapes (˜50 μm) comprising different amounts of silicone additives and excess Li and varying sintering conditions. As explained above, at least some silicone content is advantageous over tapes with 0 wt. % silicone to mitigate Li loss. FIGS. 6A-9B verify that both excess Li amount and silicone amount impact tape sintering. For example, for tapes having an excess Li content of 15%, those with the lowest added silicone amount (2 wt. %) exemplify the densest microstructure (FIGS. 6B and 7B) while those with the highest added silicone amount (8 wt. %) show the most porous structure (FIGS. 6D and 7D). From FIGS. 8A-9B, it is shown that too much excess Li (50%) results in unwanted loose grain connections (intergranular fracture) or abnormal and relatively large grain growth in garnet; fine grain structure is essential for high strength thin membranes. Since abnormal grain growth occurs at high Li concentration, the SEM images for samples with and without silicone show that samples with silicone contain more Li at the sintering condition. In other words, not only is there excess Li, but also, the presence of silicone mitigates Li loss, thereby resulting in a higher Li concentration. This result emphasizes, again, that silicone-added tapes retain more lithium.

Table 5 below provides Li₂O wt. % as a function of silica content inside the sintered Ta-LLZO tapes after sintering at 1200° C. for various times, as measured by inductively coupled plasma (ICP). The data confirms that Li-silicate in tapes prevent Li-loss, especially for samples close to stoichiometric Li-level (e.g., 11.1% Li₂O). Li-loss from garnet is more difficult than from excess Li species such as Li₂CO₃, Li₂O, LiOH, etc. Li-silicate raises the Li-loss temperature for these added excess Li species and retains more excess Li at higher temperature. For example, in the 2 wt. % silicone tape, only 1 wt. % is SiO₂. The more Li kept by this small amount of Li-silicate may be lower than the ICP detection sensitivity.

TABLE 5

| Ta-LLZO + | Excess Li | Li₂O wt. % when | Li₂O wt. % when |
|---|---|---|---|
| silicone | Content | sintering at 1200° C. | sintering at 1200° C. |
| content (wt. %) | (%) | for 3 min or 5 min | for 10 min or 15 min |
| 0 | 15 | 11.3 | 10.7 |
| 2 | | 11.2 | 10.8 |
| 5 | | 11.5 | 11.2 |
| 8 | | 11.5 | 11.2 |
| 0 | 50 | 14.5 | 12.6 |
| 5 | | 14.6 | 12.6 |

FIG. 10 illustrates electrochemical impedance spectroscopy (EIS) curves from garnet membranes with (5 wt. % silicone) and without silicone additives in green tapes (using Au electrodes). Both samples were sintered at 1250° C./3min Similar to the data of FIG. 5, unexpectedly, both tapes (comprising a silicone content of either 0 wt. % or 5 wt. %) have the same Li-ion conductivity of 3×10⁻⁴ S/cm (e.g., within the range of 1×10⁻⁴ to 3.5×10⁻⁴ S/cm) even though when a second phase is added at the grain boundary, it is expected Li-ion conductivity would severely decrease. These higher conductivities indicate that sintering at elevated temperatures (e.g., 1250° C.) is sufficient to form densified films. The same Li-ion conductivity for with and without Li-silicate indicates that Li-silicate stays at the tri-geminal grain boundaries of garnet.

TABLE 6

| Ta-LLZO + | | | |
|---|---|---|---|
| silicone | | Lattice | |
| content | Sintering | Constant | Phase Quantification |
| (wt. %) | Condition | of Garnet (Å) | Cubic garnet |
| 0 | 1200° C./5 min | 12.9374 | 100 wt. % cubic garnet |
| 0 | 1200° C./10 min | 12.93412 | 100 wt. % cubic garnet |
| 0 | 1250° C./5 min | 12.93423 | 97.40 wt. % cubic garnet |
| | | | 2.60 wt. % La₂Zr₂O₇ |
| 0 | 1250° C./10 min | 12.93354 | 85.40 wt. % cubic garnet |
| | | | 12.20 wt. % La₂Zr₂O₇ |
| | | | 2.40 wt. % LaTaO₄ |
| 2 | 1200° C./10 min | 12.93673 | 93.50 wt. % cubic garnet |
| | | | 5.20 wt. % La₂Zr₂O₇ |
| | | | 1.30 wt. % LaTaO₄ |
| 5 | 1200° C./5 min | 12.93632 | 100 wt. % cubic garnet |
| 5 | 1200° C./10 min | 12.93708 | 100 wt. % cubic garnet |
| 5 | 1250° C./5 min | 12.93509 | 93.30 wt. % cubic garnet |
| | | | 5.60 wt. % La₂Zr₂O₇ |
| | | | 1.10 wt. % LaTaO₄ |
| 5 | 1250° C./10 min | 12.93581 | 100 wt. % cubic garnet |
| 8 | 1200° C./10 min | 12.93635 | 98.80 wt. % cubic garnet |
| | | | 1.20 wt. % La₂Zr₂O₇ |

Table 6 discloses the XRD-measured phase compositions of sintered Li-silicate/Ta-LLZO tapes and pure Ta-LLZO tapes. Most samples have high concentrations of cubic garnet phase exceeding 93 wt. % cubic garnet. High cubic phase ensures a high ionic conductivity. The presence of La₂Zr₂O₇ and LaTaO₄ are auxiliary products of garnet decomposition. These are different from the desired Li-silicate second phase, which stays at grain boundaries or the tri-boundary points. These auxiliary products appear as large agglomerates (multiple garnet grains size) and pores in the sintered tapes. An excess of the auxiliary products leads conductivity decreases and weaker tape strength. For example, for samples without Li-silicate being fired at higher temperatures for longer time periods, the tape loses too much Li, causing the cubic garnet phase to decrease to 85.4 wt. %. Consequently, an increase in auxiliary products also increases. Samples with Li-silicate may retain their 100 wt. % cubic phase due to Li-silicate reduced Li-loss. Moreover, samples with (2 wt. % to 8 wt. %) and without (0 wt. %) Li-silicate have approximately the same lattice constant, indicating that Si is not doped into the garnet lattice and that Li-silicate stays at the grain boundary or the tri-boundary points.

### Example 6—Comparison of Sintering Processes

Conventional sintering involves a heating and/or cooling ramp rate of 1-10° C./min (60-600° C./hr), while the sintering process described in the present application (i.e., “fast firing”) involves a heating and/or cooling ramp rate of 100-600° C./min.

As disclosed herein, thin garnet tape is formed by adding excess Li (e.g., as in a form of Li₂CO₃) into the green tape to compensate for Li loss during sintering to obtain a densely sintered structure (i.e., relative density >98%) with high cubic garnet phase concentration (close to 100%). Fast firing suppresses Li-loss by shorten temperature ramping time (Li-loss is significant when temperature is greater than 900° C.), which enables garnet tape sintering at hasher conditions. With Li-loss sufficiently reduced, the needed excess Li in green tape may also be reduced. For example, in a 0.5Ta-LLZO green tape of about 100 μm thickness, (A) when firing in argon, only a 5-10% excess Li is needed in fast firing while more than 20% excess Li is needed in conventional sintering; or (B) when firing in ambient air, only about 15-20% excess Li is needed in fast firing while more than 50% excess Li is needed in conventional sintering.

### Example 7—Characterization Techniques

### Morphology and Phase Analysis

Scanning electron microscopy (SEM) images were obtained by a scanning electron microscope (JEOL, JSM-6010PLUS/LA). X-ray powder diffraction (XRD) patterns were obtained by x-ray powder diffraction (Bruker, D4, Cu—Kα radiation, λ=1.5415Å) in the 2θ range of 10-80° at room temperature. Inductively coupled plasma (ICP) measurements were conducted using a HF/HClO4 fuming procedure (fume to dryness twice), then dissolve residue in HCl. Li analysis was conducted using a Perkin Elmer PinnAAcle 500.

### Electrochemical Impedance Spectroscopy (EIS)

EIS was measured by AC impedance analysis (Solartron SI 1287) with a frequency range of 0.1 Hz to 1 MHz.

Thus, as presented herein, this disclosure relates to improved lithium-garnet composite ceramic electrolytes for enhanced grain boundary bonding of Li-garnet electrolytes in solid-state lithium metal battery applications. The enhanced grain boundary composition helps to resist harmful Li-dendrite growth.

Specifically, this application discloses a Li-garnet composite ceramic comprising a lithium garnet cubic major phase (e.g., LLZO, as defined above) and a lithium dendrite growth inhibitor minor phase (e.g., SA, as defined above). In some examples, the major phase may be doped with at least one of In, Si, Ge, Sn, Sb, Sc, Ti, Hf, V, W, Te, Nb, Ta, Al, Ga, Fe, Bi, Y, Mg, Ca, or combinations thereof and the minor phase comprises a second additive oxide selected from the group Li-silicate, Li-gallate, Li-aluminate, Li-tungstate, Li-molinate, Li—Ta oxide, Li—Nb-oxide, Li—Sn-oxide, Li—In-oxide, Li—As-oxide, Li—Sb-oxide, Li-phosphate, or combinations thereof, present in from >0-10 wt. % based on the total amount of the ceramic. The additive may improve uniformity of the ceramic microstructure and enhance mechanical properties of the ceramic. Because samples with and without the second phase have similar lattice constants, this indicates that the second (i.e., minor) phase (e.g., Li-silicate) remains at the grain boundary or the tri-boundary points and is not introduced into the Li-garnet.

This application also discloses a process of making a thin membrane of the Li-metal oxide/garnet composite with dense structure, high cubic phase and high Li-ion conductivity. The process includes (1) preparation of Li-garnet composite ceramic powder; (2) garnet powder passivation; (3) slip making by addition of Li-metal oxide (LMO) precursors; (4) tape casting; and (5) fast fired tape sintering green tapes into dense tapes. Li₂CO₃ in the green tape is used as a Li source to compensate Li loss during sintering. It may also generate a liquid phase at high temperature that enhances the sintering. The composite garnet tape sintering is conducted at a temperature range of 1000° C.-1300° C. for several minutes. The process disclosed herein allows the tape to be sintered in a large scale with a much-improved density.

The sintered garnet membranes have a high Li-ion conductivity (>10⁴ S/cm), thickness from 30-150 μm, and a relative density is >95%.

Advantages include: (1) addition of silicone in green tape prolongs the lifetime of the green tape (without silicone addition, non-passivated garnet powder casted tape becomes brittle within 1-2 weeks; with silicone addition, garnet tape may last several months); (2) adding silicone and Li₂CO₃ enables Li-silicate formation during sintering; (3) garnet is stable with Li-silicate; (4) Li-silicate is not Li-ion conductive and may be used to block Li-dendrite growth in garnet; (5) Li-silicate helps reduce Li-loss during sintering; and (6) other Li-metal oxides such as Li-gallate, Li-aluminate, Li-tungstate, Li-molinate, Li—Ta oxide, Li—Nb-oxide, Li—Sn-oxide, Li—In-oxide, Li—As-oxide, Li—Sb-oxide, Li-phosphate, or combinations thereof at garnet grain boundaries may also block Li-dendrite penetration through the grain boundaries.

It will be apparent to those skilled in the art that various modifications and variations can be made without departing from the spirit or scope of the claimed subject matter. Accordingly, the claimed subject matter is not to be restricted except in light of the attached claims and their equivalents.

1. A sintered composite ceramic, comprising:
a lithium-garnet major phase; and
a lithium dendrite growth inhibitor minor phase,
wherein the lithium dendrite growth inhibitor minor phase comprises a Li-metal oxide in a range of >0-10 wt. % based on the total weight of the sintered composite ceramic.

2. The sintered composite ceramic of claim 1, wherein the lithium-garnet major phase comprises at least one of:
(i) Li₇₋₃ₐLa₃Zr₂LₐO₁₂, with L=Al, Ga or Fe and 0<a<0.33;
(ii) Li₇La_{3-b}Zr₂M_{b}O₁₂, with M=Bi, Ca, or Y and 0<b<1;
(iii) Li_{7-c}La₃(Zr_{2-c}, N_{c})O₁₂, with N=In, Si, Ge, Sn, Sb, Sc, Ti, Hf, V, W, Te, Nb, Ta, Al, Ga, Fe, Bi, Y, Mg, Ca, or combinations thereof and 0<c<1, or
a combination thereof.

3. The sintered composite ceramic of claim 1 or claim 2, wherein the lithium-garnet major phase comprises:
Li_{7-c}La₃(Zr_{2-c}, N_{c})O₁₂, with N=Ta, Ga, W, or combinations thereof, and 0<c<1.

4. The sintered composite ceramic of claim 1, wherein the Li-metal oxide comprises: Li-silicate, Li-gallate, Li-aluminate, Li-tungstate, Li-molinate, Li—Ta oxide, Li—Nb-oxide, Li—Sn-oxide, Li—In-oxide, Li—As-oxide, Li—Sb-oxide, Li-phosphate, or combinations thereof.

5. The sintered composite ceramic of claim 1, wherein the metal oxide comprises Li-silicate.

6. The sintered composite ceramic of claim 1, wherein the lithium-garnet major phase comprises at least 90 wt. % of a lithium garnet cubic phase.

7. The sintered composite ceramic of claim 1, wherein a maximum grain size measured for a population of grains representing at least 5% of a total grain population does not exceed an average grain size of the total grain population by more than a multiple of 20.

8. The sintered composite ceramic of claim 1, comprising a membrane having a thickness in a range of 30-150 μm.

9. The sintered composite ceramic of claim 8, wherein the membrane has a Li-ion conductivity of at least 10⁻⁴ S/cm and a relative density of at least 90% of a theoretical maximum density of the membrane.

10. A battery, comprising:
at least one lithium electrode; and
an electrolyte in contact with the at least one lithium electrode,
wherein the electrolyte is a lithium-garnet composite electrolyte comprising the sintered composite ceramic of claim 1.

11. A sintered composite ceramic, comprising:
a lithium-garnet major phase; and
a lithium dendrite growth inhibitor minor phase,
wherein the lithium-garnet major phase comprises:
Li_{7-c}La₃(Zr_{2-c}, N_{c})O₁₂, with N=Ta, Ga, W, or combinations thereof, and 0<c<1, and
the lithium dendrite growth inhibitor minor phase comprises Li-silicate in a range of >0-10 wt. % based on the total weight of the sintered composite ceramic.

12. The sintered composite ceramic of claim 11, wherein the lithium-garnet major phase comprises at least 90 wt. % of a lithium garnet cubic phase.

13. The sintered composite ceramic of claim 11, wherein a maximum grain size measured for a population of grains representing at least 5% of a total grain population does not exceed an average grain size of the total grain population by more than a multiple of 20.

14. The sintered composite ceramic of claim 11, comprising a membrane having a thickness in a range of 30-150 μm.

15. (canceled)

16. A method, comprising:
sintering a metal oxide component/garnet green tape at a temperature in a range of 950° C. to 1500° C. to form a composite ceramic, comprising:
a lithium-garnet major phase; and
a lithium dendrite growth inhibitor minor phase,
wherein the lithium dendrite growth inhibitor minor phase comprises a Li-metal oxide in a range of >0-10 wt. % based on the total weight of the sintered composite ceramic.

17. The method of claim 16, wherein the sintering comprises:
heating from room temperature to the temperature range;
holding at the temperature range for a time in a range of 1-20 min;
cooling from the temperature range to room temperature,
wherein:
a heating ramp rate (HRR) for the heating step is 100° C./min<HRR<1000° C./min, and
a cooling rate (CR) for the cooling step is 100° C./min<CR<1000° C./min.

18. The method of step 17, wherein:
the HRR is 250° C./min<HRR<750° C./min,
the CR is 250° C./min<CR<750° C./min, and
the temperature range is 1100° C. to 1300° C.

19. The method of claim 16, wherein the sintered composite ceramic comprises at least one of:
a Li-ion conductivity of at least 10⁻⁴ S/cm; and or
a relative density of at least 90% of a theoretical maximum density of the membrane.

20. The method of claim 16, wherein the metal oxide component/garnet green tape is formed by:
reacting an excess Li source with an additive to form a Li-metal oxide (LMO) precursor;
mixing the LMO precursor with a passivated garnet powder to form a garnet suspension;
adding dispersant, binder, and plasticizer to the garnet suspension to form a slip composition; and
tape casting the slip composition.

21. (canceled)

22. The method of claim 16, wherein the metal oxide component/garnet green tape is formed by:
mixing an excess Li source, a Li-metal oxide (LMO) precursor, and a passivated garnet powder to form a garnet suspension;
adding dispersant, binder, and plasticizer to the garnet suspension to form a slip composition; and
tape casting the slip composition.
